(19) United States
(12) Patent Application Publication
(10) Pub. No.: US 2026/0050644 A1
(43) Pub. Date: Feb. 19, 2026

(54) METHOD FOR DISPLAYING SEARCH RESULTS, COMPUTER DEVICE, AND STORAGE MEDIUM

(71) Applicant: Douyin Vision (Beijing) Co., Ltd., Beijing (CN)

(72) Inventor: Yiwen WU, Beijing (CN)

(21) Appl. No.: 18/848,805

(22) PCT Filed: May 17, 2023
(86) PCT No.: PCT/CN2023/094759

§ 371 Date: Apr. 21, 2025

(30) Foreign Application Priority Data
Jun. 10, 2022 (CN) 202210654190.3

(51) Int. Cl. G06F 16/9538; G06F 16/906

(52) U.S. Cl. CPC G06F 16/9538; G06F 16/906

(57) ABSTRACT

The present disclosure relates to a method for displaying search results, a computer device and a storage medium. The method for displaying search results includes: receiving search information, in which the search information includes a keyword having a consumption intention; obtaining an aggregation search result, in which the aggregation search result comprises feature information of target objects under a plurality of consumption attribute dimensions, the consumption attribute dimensions are determined based on a category of the keyword, and the target objects match with the keyword; and displaying dimension information representing the consumption attribute dimensions and the feature information of the target objects under the consumption attribute dimensions on a search result page.

The present application claims the priority and benefits of Chinese Patent Application No. 202210654190.3, filed on Jun. 10, 2022, which is incorporated herein by reference in its entirety as part of the present application.

### TECHNICAL FIELD

Embodiments of the present disclosure relate to a method and an apparatus for displaying search results, a computer device, and a storage medium.

### BACKGROUND

With the development of internet technologies, online consumption gradually becomes an important consumption mode for people, such as online shopping, online hotel reservation, and online meal reservation.

Usually, after users search for each consumption object (such as commodities, and shops), the users may understand information of the consumption object based on various information items in search results. After comparing the information of a plurality of the consumption objects, the users reconfirm consumption intentions. How to enable the users to compare detailed information of the consumption objects more intuitively by the information items, and thus determine the consumption intentions more quickly, is a worthwhile research question.

### SUMMARY

Embodiments of the present disclosure at least provide a method and an apparatus for displaying search results, a computer device, and a storage medium.

In a first aspect, an embodiment of the present disclosure provides a method for displaying search results, and the method includes:
receiving search information, the search information includes a keyword having a consumption intention;
obtaining an aggregation search result; the aggregation search result includes feature information of target objects under a plurality of consumption attribute dimensions, the consumption attribute dimensions are determined based on a category of the keyword, and the target objects match with the keyword; and
displaying dimension information representing the consumption attribute dimensions and the feature information of the target objects under the consumption attribute dimensions on a search result page.

In an optional implementation mode, the displaying dimension information representing the consumption attribute dimensions and the feature information of the target objects under the consumption attribute dimensions on a search result page, includes:
displaying the dimension information representing the consumption attribute dimensions in a first area of the search result page; and in response to a triggering operation for any of the dimension information, displaying the feature information of the target objects under the dimension information in a second area; or,
on the search result page, according to an arrangement sequence of the consumption attribute dimensions, sequentially displaying dimension information corresponding to the consumption attribute dimensions respectively and feature information of the target objects corresponding to the consumption attribute dimensions respectively, in which the dimension information and the feature information of the target objects under each consumption attribute dimension are displayed in adjacent positions.

In an optional implementation mode, the feature information of the target objects under the consumption attribute dimensions includes different attribute characteristics of the target objects under the consumption attribute dimensions;
displaying the feature information of the target objects, includes:
under the consumption attribute dimensions, displaying feature information of a target object that meets a preset requirement in a first format, and displaying feature information of a target object that does not meet the preset requirement in a second format, in which the preset requirement includes: a comparison result of comparing an attribute characteristic of a target object with an attribute characteristic of other target objects under the consumption attribute dimensions meets a preset condition.

In an optional implementation mode, in a case that the keyword corresponds to a same type of target objects, the aggregation search result includes: feature information of a plurality of target objects belonging to the same type of target objects under each of the consumption attribute dimensions.

In an optional implementation mode, in a case that the keyword corresponds to a plurality of target objects, the aggregation search result includes: type information of the plurality of the target objects matched with the keyword, and feature information of a plurality of the target objects belonging to the target object under the plurality of the consumption attribute dimensions under the type information of each type of the target objects.

In an optional implementation mode, the method further includes:
displaying a feature comparison result under the consumption attribute dimensions obtained based on feature information of the target objects on the search result page; the feature comparison result is used to indicate a target object of which a corresponding feature comparison result under the consumption attribute dimensions meets a preset condition.

In an optional implementation mode, the method further includes:
in response to a triggering operation on feature information of any of the target objects, displaying detailed information of the target object on the search result page or other pages redirected; the detailed information includes purchasing entry information.

In an optional implementation mode, the consumption attribute dimensions include an evaluation dimension; the feature information includes evaluation information;
the displaying dimension information representing the consumption attribute dimensions and the feature information of the target objects under the consumption attribute dimensions on a search result page, includes:
displaying, on the search result page, dimension information of the evaluation dimension, and the evaluation information of the target objects under each evaluation attribute in a plurality of evaluation attributes.

In an optional implementation mode, the consumption attribute dimension includes a purchasing channel dimension; the feature information includes purchasing link information;
the displaying dimension information representing the consumption attribute dimensions and the feature information of the target objects under the consumption attribute dimensions on a search result page, includes:
displaying, on the search result page, dimension information of the purchasing channel dimension, and the purchasing link information of the target object under each purchasing channel in a plurality of the purchasing channels.

In a second aspect, an embodiment of the present disclosure provides an apparatus for displaying search results, and the apparatus for displaying search results includes: a receiving module, an obtaining module, and a first display module.

The receiving module is configured to receive search information, the search information includes a keyword having a consumption intention.

The obtaining module is configured to obtain an aggregation search result, the aggregation search result includes feature information of target objects under a plurality of consumption attribute dimensions, the consumption attribute dimensions are determined based on a category of the keyword, and the target objects match with the keyword.

The first display module is configured to display dimension information representing the consumption attribute dimensions and the feature information of the target objects under the consumption attribute dimensions on a search result page.

In a third aspect, an embodiment of the present disclosure further provides a computer device, and the computer device includes: a processor, a memory, and a bus, the memory stores a machine-readable instruction executable by the processor, when the computer device runs, the processor communicates with the memory by the bus, and the steps of the method for displaying search results in the above first aspect or any one of the first aspect are executed when the machine-readable instruction is executed by the processor.

In a fourth aspect, an embodiment of the present disclosure further provides a computer-readable storage medium, a computer program is stored in the computer-readable storage medium, and the steps of the method for displaying search results in the above first aspect or any one of the first aspect are executed when the computer program is executed by a processor.

Embodiments of the present disclosure provide a method for displaying search results, by collectively displays the dimension information of the consumption attribute dimensions matched with the category of the keyword searched by a user in a form of the aggregation search result, as well as the feature information of the target objects under the consumption attribute dimensions, so that the user can have relatively comprehensive understanding of the feature information of the target objects under the category corresponding to the searched keyword after viewing the aggregation search result, and the user can intuitively compare the feature information of the target objects without the need to view complex information items separately, and thus the consumption intension can be relatively quickly determined.

In order to make the above purposes, features, and advantages of the present disclosure more apparent and understandable, the following text provides preferred embodiments together with attached drawings, and the detailed description is provided as follows.

### BRIEF DESCRIPTION OF DRAWINGS

In order to describe technical schemes in embodiments of the present disclosure more clearly, drawings required in the embodiments are briefly introduced below, and the drawings herein are incorporated into the description and constitute a part of the description. These drawings show the embodiments that comply with the present disclosure and are used together with the description to describe the technical schemes of the present disclosure. It should be understood that the following drawings only show some of the embodiments of the present disclosure, and therefore should not be regarded as limiting the scope. For those of ordinary skill in the art, other relevant drawings may also be obtained based on these drawings without paying creative labor.

FIG. 1 shows a flow diagram of a method for displaying search results provided in an embodiment of the present disclosure;

FIG. 2 shows a schematic diagram of a search result page provided in an embodiment of the present disclosure;

FIG. 3 shows a schematic diagram of another search result page provided in an embodiment of the present disclosure;

FIG. 4 shows a schematic diagram of another search result page provided in an embodiment of the present disclosure;

FIG. 5 shows a schematic diagram of another search result page provided in an embodiment of the present disclosure;

FIG. 6 shows a schematic diagram of another search result page provided in an embodiment of the present disclosure;

FIG. 7 shows a schematic diagram of an apparatus for displaying search results provided in an embodiment of the present disclosure; and

FIG. 8 shows a structure schematic diagram of a computer device provided in an embodiment of the present disclosure.

### DETAILED DESCRIPTION

In order to make purposes, technical schemes, and advantages of embodiments of the present disclosure clearer, the technical schemes in the embodiments of the present disclosure are clearly and completely described below in combination with drawings in the embodiments of the present disclosure. Apparently, the embodiments described are only a part of the embodiments of the present disclosure, not all of the embodiments. Generally, components of the embodiments of the present disclosure described and shown in the drawings herein may be arranged and designed in various different configurations. Therefore, the following detailed description of the embodiments of the present disclosure provided in the drawings is not intended to limit the scope of protection claimed by the present disclosure, but only to represent the selected embodiments of the present disclosure. Based on the embodiments of the present disclosure, all other embodiments obtained by those skilled in the art without paying creative labor shall fall within the scope of protection of the present disclosure.

In addition, the terms “first”, “second” and the like in the description and claims in the embodiments of the present disclosure, as well as the above drawings, are used to distinguish similar objects and do not necessarily need to be used to describe a specific sequence or a precedence order. It should be understood that data used in this way may be interchanged in appropriate situations, so that the embodiments described here may be implemented in an order other than those illustrated or described here.

The term “plurality” mentioned in this article refers to two or more. The “and/or” describes an association relationship of associated objects, it represents that there may be three types of relationships, such as A and/or B, it may represent three situations: the existence of A alone, the coexistence of A and B, and the existence of B alone. The character “/” generally represents that the front and rear associated objects are an “or” relationship.

It is found by researches that when a user searches for a consumption object, a plurality of information items of at least one consumption object may be displayed on a search result page, and each information item displays detailed information about a certain aspect of a certain consumption object, such as one information item displays shop details, another information item displays purchasing channel information, and another information item displays class information. The user needs to view each information item before the user may understand all the detailed information of a certain consumption object. How to enable the user to compare the detailed information of the consumption objects more intuitively and determine a consumption intention more quickly is a worthwhile research question.

Based on the above researches, an embodiment of the present disclosure provides a method for displaying search results. After search information including a keyword having the consumption intention is received, an aggregation search result is obtained, and the aggregation search result includes feature information of the target objects under a plurality of consumption attribute dimensions related to the category corresponding to the keyword. In this way, the dimension information representing the consumption attribute dimensions and the feature information of the target objects under the consumption attribute dimensions may be displayed on the search result page.

Based on the above method for displaying search results, by collectively displaying the dimension information of the consumption attribute dimensions corresponding to the category related to user search information in the form of the aggregation search result, as well as the feature information of the target objects under the consumption attribute dimensions, so that the user can have relatively comprehensive understanding of the feature information of the target objects under the category corresponding to the search information by viewing the aggregation search result once, and the user may intuitively compare the feature information of the target objects, and thus the consumption intension can be relatively quickly determined.

The shortcomings of the above schemes and the proposed solution schemes are all results obtained by the inventor after practices and careful researches. Therefore, the discovery process of the above problems and the solution schemes proposed in the present disclosure for the above problems in the following text should be contributions made by the inventor to this disclosure process.

It should be noted that: similar labels and letters represent similar terms in the following drawings. Therefore, once a certain term is defined in one drawing, it does not need to be further defined or explained in the subsequent drawings.

For the convenience of understanding this embodiment, a method for displaying search results disclosed in an embodiment of the present disclosure is firstly introduced in detail, and the execution subject of the method for displaying search results provided in the embodiment of the present disclosure is generally a computer device with certain computing power.

The execution subject as a terminal device is taken as an example, and the method for displaying search results provided in the embodiment of the present disclosure is described below.

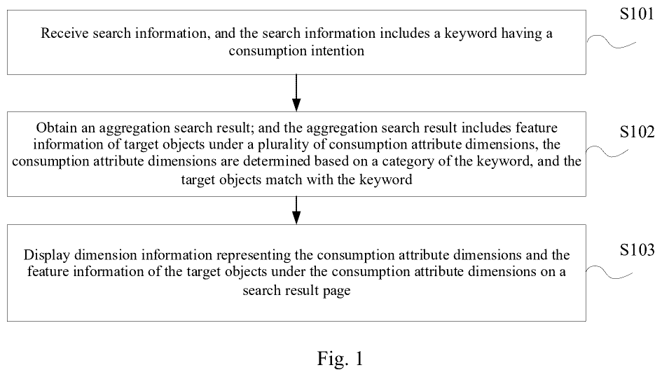

As shown in FIG. 1, it is a flow diagram of a method for displaying search results provided in an embodiment of the present disclosure, and the method includes S101˜S103:

S101: receive search information, and the search information includes a keyword having a consumption intention.

In the embodiment of the present disclosure, the search information may be information input by the user on the search page, or historical search information selected by the user in a historical search record. The keyword having the consumption intention contained in the search information may be a keyword related to any consumption objects (namely a target object in the following text), it may be divided into commodities, foods, tourism, travel services and the like according to the category of the keyword, it is not specifically limited here. The keyword may be at least one of the target object's information such as name, class, and brand and the like, it is not specifically limited here. The keyword may be a full name, an abbreviation and the like of the above information, it is not specifically limited here.

S102: obtain an aggregation search result; and the aggregation search result includes feature information of target objects under a plurality of consumption attribute dimensions, the consumption attribute dimensions are determined based on a category of the keyword, and the target objects match with the keyword.

In the embodiment of the present disclosure, the aggregation search result may be an aggregation search result determined by a server based on the received search information sent by the terminal device to the server.

Here, the consumption attribute dimension may include a class dimension, a price dimension, a logistics dimension, an evaluation dimension, a purchasing channel dimension and the like of the target object. In other ways, the consumption attribute dimension may also include other dimensions, it is not specifically limited here. The feature information here may refer to attribute characteristics of the target object under the same consumption attribute dimension; for example, feature information of the target objects under the class dimension may include class information of the target objects; for another example, feature information of the target objects under the price dimension may include price information of the target objects, such as a present price, and a discounted price; feature information of the target objects under the logistics dimension may include logistics information of the target objects, such as a logistics speed, a logistics transportation time, and a logistics name; feature information of the target objects under the evaluation dimension may include evaluation information of the target objects. The evaluation information may be a result obtained from other users evaluating the target object, or may be an evaluation result obtained by merchants according to the evaluation information of the purchasing user. The evaluation information may include a comparison result for a plurality of target objects in the same category, such as which one has a higher cost-performance ratio; and the evaluation information may also include an evaluation result for a certain target object, such as how to use it more effectively. Feature information of the target objects under the purchasing channel dimension may include purchasing link information, purchasing mode information and the like of the target objects.

The aggregation search result may include some or all of the above consumption attribute dimensions. The consumption attribute dimensions may be determined according to the category of the keyword. For example, the category of the keywords is the commodities, and the consumption attribute dimension may be the logistics dimension, the price dimension, the purchasing channel dimension and the like. For another example, the category of the keyword is the tourism, and the consumption attribute dimension may be a scenic spot ranking dimension, a travel mode dimension and the like.

The category corresponding to the keyword may be determined according to at least one information of the target object contained such as the name, brand, and class and the like. When the keyword is the name of the target object, the category to which the target object belongs may be determined according to the name, namely the category corresponding to the keyword; when the keyword is the class of the target object, the category of the keyword may be directly determined according to the class; when the keyword is the brand of the target object, the class of the target object may be determined according to the brand, namely the category corresponding to the keyword is determined; alternatively, the name of the target object is firstly determined according to the brand, and then the class of the target object is determined according to the name of the target object, namely the category corresponding to the keyword is determined.

The target object matched with the keyword may include at least one. Herein, in a case that the keyword corresponds to a same type of target objects, the aggregation search result may include feature information of a plurality of target objects belonging to the same type of target objects under each of the consumption attribute dimensions. For example, the target object corresponding to the keyword is a lipstick, and the aggregation search result may include feature information of different lipsticks under a lipstick class.

In a case that the keyword corresponds to a plurality of target objects, the aggregation search result may include type information of the plurality of the target objects matched with the keyword, as well as feature information of a plurality of the target objects belonging to the target object under the plurality of consumption attribute dimensions in the type information of each type of the target objects. For example, when the keyword is a summer clothing, and the type of the target object is skirts, shorts, short sleeved tops and the like, the aggregation search result may include information on the types of the skirts, shorts, short sleeved tops and the like, as well as feature information of different skirts under the plurality of the consumption attribute dimensions in the skirt type; feature information of different shorts under the plurality of the consumption attribute dimensions in the shorts type; and feature information of different short sleeved tops under the plurality of the consumption attribute dimensions in the short sleeved top type.

S103: display dimension information representing the consumption attribute dimensions and the feature information of the target objects under the consumption attribute dimensions on a search result page.

Here, the aggregation search result may be presented in a form of an information card, and the dimension information representing each attribute dimension and the feature information of the target objects under the consumption attribute dimensions may be displayed in the information card. In other words, the dimension information representing each attribute dimension and the feature information of the target objects under the consumption attribute dimensions may be displayed in one information card, so that the user may obtain the comprehensive feature information in a one-time and intuitive manner, and thus the consumption intention may be determined more quickly.

In order to display the information more clearly, in an implementation mode, the dimension information of the consumption attribute dimension and the feature information of the target objects under the consumption attribute dimensions may be displayed in different areas. Specifically, the dimension information representing the consumption attribute dimensions may be displayed in a first area of the search result page; and then, in response to a triggering operation for any of the dimension information, the feature information of the target objects under the dimension information is displayed in a second area.

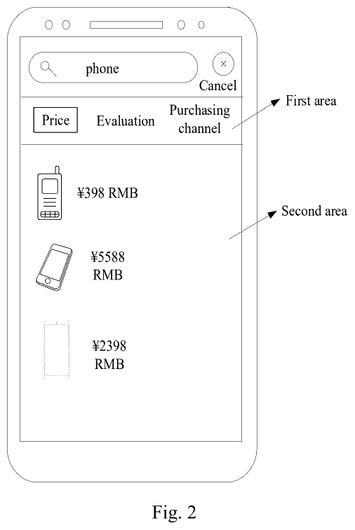

Here the triggering operation may be a clicking operation for any dimension information representing the consumption attribute dimensions, after clicking on any dimension information, the feature information of the target objects under the dimension information may be displayed in the second area. Herein, the first area and the second area may be displayed side by side on the search result page, such as up and down side by side displaying or left and right side by side displaying. The dimension information of the price dimension, the dimension information of the evaluation dimension, and the dimension information of the purchasing channel dimension are displayed in the first area. When the user clicks on the dimension information of the price dimension, the price information of the target objects may be displayed in the second area; when the user clicks on the dimension information of the evaluation dimension, the evaluation information of the target objects may be displayed in the second area; and when the user clicks on the dimension information of the purchasing channel dimension, the purchasing link information of the target objects may be displayed in the second area. As shown in FIG. 2, the first area and the second area are displayed side by side on the search result page, herein the first area is displayed above the second area. The dimension information of the price dimension, the dimension information of the evaluation dimension, and the dimension information of the purchasing channel dimension are displayed in the first area. After the user searches for “phone” and clicks on “price” in the first area, the “price” may be highlighted, and the price information of each phone may be displayed in the second area. Similarly, when the user clicks on “evaluation”, the “evaluation” may be highlighted and the evaluation information of each phone may be displayed in the second area; and when the user clicks on “purchasing channel”, the “purchasing channel” may be highlighted and the purchasing channel information of each phone may be displayed in the second area.

In an implementation mode, the dimension information corresponding to the consumption attribute dimensions respectively and feature information of the target objects corresponding to the consumption attribute dimensions respectively are also displayed sequentially on the search result page according to the arrangement sequence of the consumption attribute dimensions.

In an implementation mode, the arrangement sequence of the consumption attribute dimensions may be randomly set. In another implementation mode, the arrangement sequence of the consumption attribute dimensions may also be set according to an attention degree of the user. Herein, the attention degree of the user may be determined according to a research result of the user, it is not specifically limited here.

According to the arrangement sequence of the consumption attribute dimensions, the dimension information of the consumption attribute dimensions may be displayed side by side on the search results page, for example, side by side displaying from top to bottom, or side by side displaying from left to right, it is not specifically displayed here.

The dimension information under the consumption attribute dimensions is displayed adjacent to the feature information of the target objects. For example, the dimension information may be displayed above the corresponding feature information.

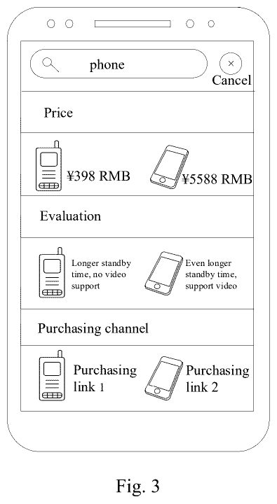

In a schematic diagram of another search result page shown in FIG. 3, searching phones is taken as an example, on the search result page, the dimension information of the price dimension, the dimension information of the evaluation dimension, and the dimension information of the purchasing channel dimension are sequentially displayed from top to bottom, and the corresponding feature information of the phone may be displayed under each dimension information.

In the embodiment of the present disclosure, the feature information of the target objects under the above consumption attribute dimensions may include different attribute characteristics of the target objects under the consumption attribute dimensions. For example, high or low characteristics of the target objects under the price dimension, transportation fast or slow characteristics of the target objects under the logistics dimension, and advantage or disadvantage characteristics of the target objects under the evaluation dimension. Usually, under the same consumption attribute dimension, the attribute characteristics of the different target objects may be different.

In order to distinguish the different target objects, in an implementation mode, when the feature information of the target objects is displayed, for the consumption attribute dimensions, under the consumption attribute dimensions, the feature information of a target object that meets a preset requirement may be displayed in a first format, and the feature information of a target object that does not meet the preset requirement may be displayed in a second format.

The preset requirement includes: a comparison result of comparing an attribute characteristic of a target object with an attribute characteristic of other target objects under the consumption attribute dimensions meets a preset condition. In this implementation mode, for example, under the price dimension, the target object with the lowest price may be used as the target object that meets the preset requirement, and other target objects may be used as the target object that does not meet the preset condition. For another example, under the logistics dimension, the target object with the fastest logistics may be used as the target object that meets the preset requirement, and other target objects may be used as the target object that does not meet the preset condition.

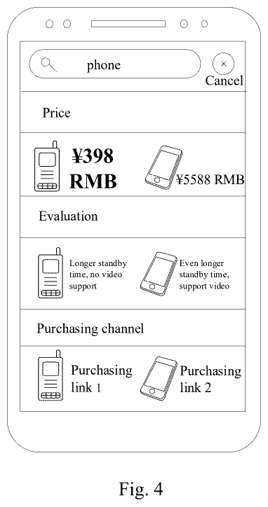

Here, the first format and the second format may differ in at least one aspect, such as font, font size, and font color and the like. In order to enable the user to more intuitively notice the feature information of the target object that meets the preset requirement, the first format may be highlighted, namely highlight the feature information of the target object that meets the preset requirement, and non-highlight the feature information of the target object that does not meet the preset requirement. In a schematic diagram of another search result page shown in FIG. 4, the displaying of the feature information of each phone is taken as an example, for the price dimension, the price information of the lowest priced phone may be displayed in bold, while the price information of other phones is not displayed in bold.

In the embodiment of the present disclosure, in order to enable the user to intuitively understand the feature information of the target objects, in an embodiment mode, the search result page may also display a feature comparison result under the consumption attribute dimensions obtained based on feature information of the target objects. In which the feature comparison result is used to indicate a target object of which a corresponding feature comparison result under the consumption attribute dimensions meets a preset condition.

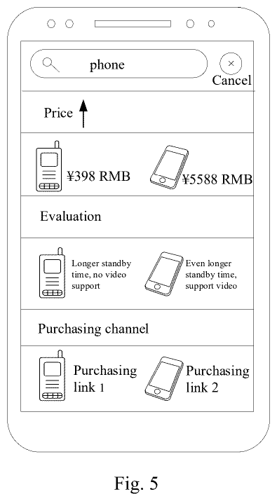

For example, when the consumption attribute dimension is the price dimension, the search result page may display the price comparison result of the target objects under the price dimension. The price comparison result may include information on high or low prices of the target objects. In a schematic diagram of another search result page shown in FIG. 5, searching phones is taken as an example, the search result page may display an indication identifier indicating the price of each phone from low to high. By the indication identifier, it may be seen that the price of the phone in the back is higher than that of the phone in the front. By displaying the feature comparison result, it is possible to more intuitively see the target object that meets the preset condition in the corresponding feature comparison result under the consumption attribute dimensions.

As mentioned earlier, the consumption attribute dimension may include a plurality of dimensions, and in an implementation mode, the consumption attribute dimension may include the evaluation dimension; and the feature information may include the evaluation information.

The step of displaying the dimension information representing the consumption attribute dimensions and the feature information of the target objects under the consumption attribute dimensions on the search result page, includes: displaying, on the search result page, dimension information of the evaluation dimension, and the evaluation information of the target objects under each evaluation attribute in a plurality of evaluation attributes.

Here, the evaluation dimension may include the plurality of the evaluation attributes. For example, for an electronic product, the evaluation attribute may include battery life evaluation, performance evaluation and the like; and for the tourism, the evaluation attribute may include environmental evaluation, comfort evaluation and the like. The different target objects may have different corresponding evaluation attributes. Here, the evaluation attribute may be determined in advance according to the target object, and then the evaluation information of the target objects may be displayed for each evaluation attribute in the plurality of the evaluation attributes.

In another implementation mode, the consumption attribute dimension may include the purchasing channel dimension; and the feature information may include the purchasing link information.

The step of displaying dimension information representing the consumption attribute dimensions and the feature information of the target objects under the consumption attribute dimensions on a search result page, includes: displaying, on the search result page, dimension information of the purchasing channel dimension, and the purchasing link information of the target object under each purchasing channel in a plurality of the purchasing channels.

Here, the purchasing channel may include a purchasing platform. The purchasing link information of the target objects on each purchasing platform may be displayed.

In the embodiment of the present disclosure, after the feature information of the target object is displayed, the detailed information of the target object may also be displayed, so that the user completes consumption. Specifically, in an implementation mode, in response to a triggering operation on feature information of any of the target objects, detailed information of the target object may be displayed on the search result page or other pages redirected, in which, the detailed information includes purchasing entry information.

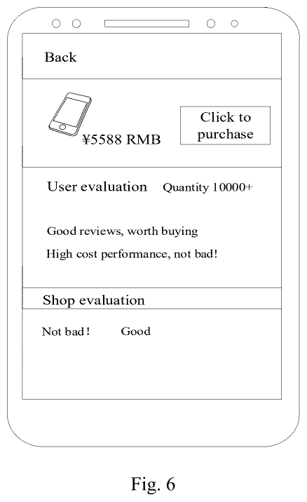

The triggering operation on the feature information of any target object may be an operation to display the detailed information of the target object, and in an implementation mode, it may be a clicking operation for the feature information of any target object. The detailed information of the target object may be displayed on the search result page or other pages. By clicking on the feature information of the target object, the detailed information of the target object may be displayed on the search result page or other pages redirected. In a schematic diagram of another search result page shown in FIG. 6, searching phones is taken as an example, the detailed information of the phone may be displayed on other pages after being redirected, and on the other pages after being redirected, the purchasing entry information for purchasing the phone may be displayed, namely a “click to purchase” button. In other implementation modes, other information in the detailed information may also be displayed, such as user evaluation information, and shop evaluation information and the like, it is not specifically limited here.

It may be understood by those skilled in the art that in the above methods of the specific implementation modes, the writing order of each step does not imply a strict execution order and imposes any limitations on the implementation process, and the specific execution order of each step should be determined based on its functions and possible internal logics.

Based on the same inventive concept, an apparatus for displaying search results corresponding to the method for displaying search results is also provided in the embodiment of the present disclosure. Since the principles of the apparatus solving the problems in the embodiment of the present disclosure are similar to that of the method for displaying search results in the embodiment of the present disclosure, the implementation of the apparatus may refer to the implementation of the method, and the repetition is not repeatedly described.

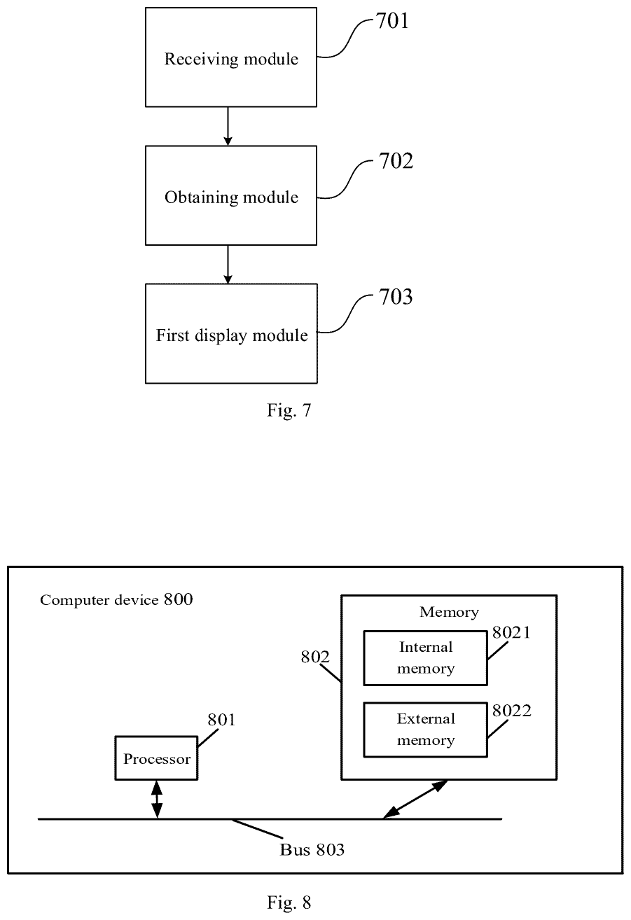

As shown in FIG. 7, it is a schematic diagram of an apparatus for displaying search results provided in an embodiment of the present disclosure, and the apparatus includes: a receiving module 701, an obtaining module 702, and a first display module 703.

The receiving module 701 is configured to receive search information, and the search information includes a keyword having a consumption intention.

The obtaining module 702 is configured to obtain an aggregation search result; and the aggregation search result includes feature information of target objects under a plurality of consumption attribute dimensions, the consumption attribute dimensions are determined based on a category of the keyword, and the target objects match with the keyword.

The first display module 703 is configured to display dimension information representing the consumption attribute dimensions and the feature information of the target objects under the consumption attribute dimensions on a search result page.

The embodiment of the present disclosure by collectively displays the dimension information of the consumption attribute dimensions matched with the category of the keyword searched by the user in the form of the aggregation search result, as well as the feature information of the target objects under the consumption attribute dimensions, so that the user may have relatively comprehensive understanding of the feature information of the target objects under the category corresponding to the searched keyword after viewing the aggregation search result, and the user may intuitively compare the feature information of the target objects without the need to view complex information items separately, and thus the consumption intension may be relatively quickly determined.

In an optional implementation mode, the first display module 703 is specifically configured to:
display the dimension information representing the consumption attribute dimensions in a first area of the search result page; and in response to a triggering operation for any of the dimension information, display the feature information of the target objects under the dimension information in a second area; or,
on the search result page, according to an arrangement sequence of the consumption attribute dimensions, sequentially display dimension information corresponding to the consumption attribute dimensions respectively and feature information of the target objects corresponding to the consumption attribute dimensions respectively, in which the dimension information and the feature information of the target objects under each consumption attribute dimension are displayed in adjacent positions.

In an optional implementation mode, the feature information of the target objects under the consumption attribute dimensions includes different attribute characteristics of the target objects under the consumption attribute dimensions;
the first display module 703 is specifically configured to:
under the consumption attribute dimensions, display feature information of a target object that meets a preset requirement in a first format, and display feature information of a target object that does not meet the preset requirement in a second format; in which the preset requirement includes: a comparison result of comparing an attribute characteristic of a target object with an attribute characteristic of other target objects under the consumption attribute dimensions meets a preset condition.

In an optional implementation mode, in a case that the keyword corresponds to a same type of target objects, the aggregation search result includes: feature information of a plurality of target objects belonging to the same type of target objects under each of the consumption attribute dimensions.

In an optional implementation mode, in a case that the keyword corresponds to a plurality of target objects, the aggregation search result includes: type information of the plurality of the target objects matched with the keyword, and feature information of a plurality of the target objects belonging to the target object under the plurality of the consumption attribute dimensions under the type information of each type of the target objects.

In an optional implementation mode, the apparatus further includes: a second display module.

The second display module is configured to display a feature comparison result under the consumption attribute dimensions obtained based on feature information of the target objects on the search result page; and the feature comparison result is used to indicate a target object of which a corresponding feature comparison result under the consumption attribute dimensions meets a preset condition.

In an optional implementation mode, the apparatus further includes: a third display module.

The third display module is configured to, in response to a triggering operation on feature information of any of the target objects, display detailed information of the target object on the search result page or other pages redirected; and the detailed information includes purchasing entry information.

In an optional implementation mode, the consumption attribute dimensions include an evaluation dimension; the feature information includes evaluation information;
the first display module 703 is specifically configured to: display, on the search result page, the dimension information of the evaluation dimension, and the evaluation information of the target objects under each evaluation attribute in a plurality of evaluation attributes.

In an optional implementation mode, the consumption attribute dimension includes a purchasing channel dimension; the feature information includes purchasing link information;
the first display module 703 is specifically configured to: display, on the search result page, the dimension information of the purchasing channel dimension, and the purchasing link information of the target object under each purchasing channel in a plurality of the purchasing channels.

The descriptions of the processing flow of each module in the apparatus and the interaction flow between various modules may refer to the relevant description in the above method embodiments, it is not elaborated here.

Based on the same technical concept, the embodiment of the present disclosure further provides a computer device. As shown in FIG. 8, it is a structure schematic diagram of a computer device 800 provided in an embodiment of the present disclosure, and the computer device 800 includes a processor 801, a memory 802, and a bus 803. The memory 802 is configured to store an execution instruction, and includes an internal memory 8021 and an external memory 8022; the internal memory 8021 here, also known as an internal storage, and the internal memory 8021 is configured to temporarily store operational data in the processor 801 and data exchanged with the external memory 8022 such as a hard disk, the processor 801 exchanges the data with the external memory 8022 by the internal memory 8021, and when the computer device 800 is run, the processor 801 communicates with the memory 802 by the bus 803, so that the processor 801 executes the following instructions:
receive search information, and the search information includes a keyword having a consumption intention;
obtain an aggregation search result; the aggregation search result includes feature information of the target objects under a plurality of consumption attribute dimensions, the consumption attribute dimensions are determined based on a category of the keyword, and the target objects match with the keyword; and
display dimension information representing the consumption attribute dimensions and the feature information of the target objects under the consumption attribute dimensions on a search result page.

The embodiment of the present disclosure by collectively displays the dimension information of the consumption attribute dimensions matched with the category of the keyword searched by the user in the form of the aggregation search result, as well as the feature information of the target objects under the consumption attribute dimensions, so that the user may have relatively comprehensive understanding of the feature information of the target objects under the category corresponding to the searched keyword after viewing the aggregation search result, and the user may intuitively compare the feature information of the target objects without the need to view complex information items separately, and thus the consumption intension may be relatively quickly determined.

The embodiment of the present disclosure further provides a computer-readable storage medium, a computer program is stored in the computer-readable storage medium, and the steps of the method for displaying search results in the above method embodiment are executed when the computer program is executed by the processor. In which, the storage medium may be a volatile or non-volatile computer-readable storage medium.

The embodiment of the present disclosure further provides a computer program product including a computer instruction, and the above method for displaying search results are implemented when the computer instruction is executed by the processor. Herein, the computer program product may be any product that may implement the above method for displaying search results, some or all of the schemes in the computer program product may be reflected in the form of a software product (such as a Software Development Kit (SDK)), the software product may be stored in a storage medium, and by the computer instruction contained, the relevant device or the processor executes some or all of the steps of the above method for displaying search results.

It may be clearly understood by those skilled in the art that for the convenience and conciseness of the description, the specific working process of the apparatus described above may refer to the corresponding process in the aforementioned method embodiment, it is not repeatedly described here. In the several embodiments provided in the present disclosure, it should be understood that the disclosed apparatus and method may be implemented in other ways. The apparatus embodiments described above are only schematic. For example, the division of the modules is only a logical function division, and there may be other division modes during actual implementation. For another example, a plurality of modules or components may be combined, or some features may be ignored or not executed. Another point is that coupling or direct coupling or communication connection between displayed or discussed may be indirect coupling or communication connection by some communication interfaces, apparatuses or modules, which may be electrical, mechanical or other forms.

The units described as separate components may be or may not be physically separated, and the components displayed as the units may be or may not be physical units, namely it may be located in one place or distributed on a plurality of network units. Some or all units of which may be selected according to actual needs to achieve the purpose of the scheme in this embodiment.

In addition, various functional modules in various embodiments of the present disclosure may be integrated into one processing module, or each module may physically exist separately, or two or more than two modules may be integrated into one module.

When the functions are implemented in the form of a software functional module and sold or used as an independent product, it may be stored in a non-volatile computer-readable storage medium that may be executed by the processor. Based on this understanding, the technical scheme of the present disclosure may essentially or partially be embodied in the form of a software product, the computer software product is stored in a storage medium and includes a plurality of instructions to enable a computer device (it may be a personal computer, a server, or a network device or the like) to perform all or part of the steps of the method in each embodiment of the present disclosure. The aforementioned storage medium includes: a universal serial bus (USB) flash drive, a portable hard drive, a Read-Only Memory (ROM), a Random Access Memory (RAM), a magnetic disk or an optical disk, and other media that may store a program code.

Finally, it should be noted that: the above embodiments are only specific implementation modes of the present disclosure, used to describe the technical schemes of the present disclosure, and not to limit it. The scope of protection of the present disclosure is not limited to this. Although the present disclosure is described in detail with reference to the aforementioned embodiments, those of ordinary skill in the art should understand that: any technical personnel familiar with this technical field may still modify or easily think of changes to the technical schemes recorded in the aforementioned embodiments within the scope of technologies disclosed in the present disclosure, or replace some of the technical features equivalently; and these modifications, changes, or replacements do not make the essence of the corresponding technical schemes deviate from the spirit and scope of the technical schemes in the embodiments of the present disclosure, and should be encompassed within the scope of protection of the present disclosure. Therefore, the scope of protection of the present disclosure shall be based on the scope of protection of the claims.

1. A method for displaying search results, comprising:
receiving search information, wherein the search information comprises a keyword having a consumption intention;
obtaining an aggregation search result, wherein the aggregation search result comprises feature information of target objects under a plurality of consumption attribute dimensions, the consumption attribute dimensions are determined based on a category of the keyword, and the target objects match with the keyword; and
displaying dimension information representing the consumption attribute dimensions and the feature information of the target objects under the consumption attribute dimensions on a search result page.

2. The method according to claim 1, wherein the displaying dimension information representing the consumption attribute dimensions and the feature information of the target objects under the consumption attribute dimensions on a search result page, comprises:
displaying the dimension information representing the consumption attribute dimensions in a first area of the search result page; and in response to a triggering operation for any of the dimension information, displaying the feature information of the target objects under the dimension information in a second area; or,
on the search result page, according to an arrangement sequence of the consumption attribute dimensions, sequentially displaying dimension information corresponding to the consumption attribute dimensions respectively and feature information of the target objects corresponding to the consumption attribute dimensions respectively, wherein the dimension information and the feature information of the target objects under each consumption attribute dimension are displayed in adjacent positions.

3. The method according to claim 1, wherein the feature information of the target objects under the consumption attribute dimensions comprises different attribute characteristics of the target objects under the consumption attribute dimensions;
displaying the feature information of the target objects, comprises:
under the consumption attribute dimensions, displaying feature information of a target object that meets a preset requirement in a first format, and displaying feature information of a target object that does not meet the preset requirement in a second format, wherein the preset requirement comprises: a comparison result of comparing an attribute characteristic of a target object with an attribute characteristic of other target objects under the consumption attribute dimensions meets a preset condition.

4. The method according to claim 1, wherein in a case that the keyword corresponds to a same type of target objects, the aggregation search result comprises: feature information of a plurality of target objects belonging to the same type of target objects under each of the consumption attribute dimensions.

5. The method according to claim 1, wherein in a case that the keyword corresponds to a plurality of target objects, the aggregation search result comprises: type information of the plurality of the target objects matched with the keyword, and feature information of a plurality of the target objects belonging to the target object under the plurality of the consumption attribute dimensions under the type information of each type of the target objects.

6. The method according to claim 1, further comprising:
displaying a feature comparison result under the consumption attribute dimensions obtained based on feature information of the target objects on the search result page, wherein the feature comparison result is used to indicate a target object of which a corresponding feature comparison result under the consumption attribute dimensions meets a preset condition.

7. The method according to claim 1, further comprising:
in response to a triggering operation on feature information of any of the target objects, displaying detailed information of the target object on the search result page or other pages redirected, wherein the detailed information comprises purchasing entry information.

8. The method according to claim 1, wherein the consumption attribute dimensions comprise an evaluation dimension, and the feature information comprises evaluation information;
the displaying dimension information representing the consumption attribute dimensions and the feature information of the target objects under the consumption attribute dimensions on a search result page, comprises:
displaying, on the search result page, dimension information of the evaluation dimension, and the evaluation information of the target objects under each evaluation attribute in a plurality of evaluation attributes.

9. The method according to claim 1, wherein the consumption attribute dimension comprises a purchasing channel dimension, and the feature information comprises purchasing link information;
the displaying dimension information representing the consumption attribute dimensions and the feature information of the target objects under the consumption attribute dimensions on a search result page, comprises:
displaying, on the search result page, dimension information of the purchasing channel dimension, and the purchasing link information of the target object under each purchasing channel in a plurality of the purchasing channels.

10. (canceled)

11. A computer device, comprising: a processor, a memory, and a bus, wherein the memory stores a machine-readable instruction executable by the processor, when the computer device runs, the processor communicates with the memory by the bus, and a method for displaying search results is executed when the machine readable instruction is executed, and the method comprises:
receiving search information, wherein the search information comprises a keyword having a consumption intention;
obtaining an aggregation search result, wherein the aggregation search result comprises feature information of target objects under a plurality of consumption attribute dimensions, the consumption attribute dimensions are determined based on a category of the keyword, and the target objects match with the keyword; and
displaying dimension information representing the consumption attribute dimensions and the feature information of the target objects under the consumption attribute dimensions on a search result page.

12. A non-transitory computer-readable storage medium, wherein a computer program is stored in the computer-readable storage medium, and a method for displaying search results is executed when the computer program is executed by a processor, and the method comprises:
receiving search information, wherein the search information comprises a keyword having a consumption intention;
obtaining an aggregation search result, wherein the aggregation search result comprises feature information of target objects under a plurality of consumption attribute dimensions, the consumption attribute dimensions are determined based on a category of the keyword, and the target objects match with the keyword; and
displaying dimension information representing the consumption attribute dimensions and the feature information of the target objects under the consumption attribute dimensions on a search result page.

13. The computer device according to claim 11, wherein the displaying dimension information representing the consumption attribute dimensions and the feature information of the target objects under the consumption attribute dimensions on a search result page, comprises:
displaying the dimension information representing the consumption attribute dimensions in a first area of the search result page; and in response to a triggering operation for any of the dimension information, displaying the feature information of the target objects under the dimension information in a second area; or,
on the search result page, according to an arrangement sequence of the consumption attribute dimensions, sequentially displaying dimension information corresponding to the consumption attribute dimensions respectively and feature information of the target objects corresponding to the consumption attribute dimensions respectively, wherein the dimension information and the feature information of the target objects under each consumption attribute dimension are displayed in adjacent positions.

14. The computer device according to claim 11, wherein the feature information of the target objects under the consumption attribute dimensions comprises different attribute characteristics of the target objects under the consumption attribute dimensions;
displaying the feature information of the target objects, comprises:
under the consumption attribute dimensions, displaying feature information of a target object that meets a preset requirement in a first format, and displaying feature information of a target object that does not meet the preset requirement in a second format, wherein the preset requirement comprises: a comparison result of comparing an attribute characteristic of a target object with an attribute characteristic of other target objects under the consumption attribute dimensions meets a preset condition.

15. The computer device according to claim 11, wherein in a case that the keyword corresponds to a same type of target objects, the aggregation search result comprises: feature information of a plurality of target objects belonging to the same type of target objects under each of the consumption attribute dimensions.

16. The computer device according to claim 11, wherein in a case that the keyword corresponds to a plurality of target objects, the aggregation search result comprises: type information of the plurality of the target objects matched with the keyword, and feature information of a plurality of the target objects belonging to the target object under the plurality of the consumption attribute dimensions under the type information of each type of the target objects.

17. The computer device according to claim 11, wherein the method further comprises:
displaying a feature comparison result under the consumption attribute dimensions obtained based on feature information of the target objects on the search result page, wherein the feature comparison result is used to indicate a target object of which a corresponding feature comparison result under the consumption attribute dimensions meets a preset condition.

18. The computer device according to claim 11, wherein the method further comprises:
in response to a triggering operation on feature information of any of the target objects, displaying detailed information of the target object on the search result page or other pages redirected, wherein the detailed information comprises purchasing entry information.

19. The computer device according to claim 11, wherein the consumption attribute dimensions comprise an evaluation dimension, and the feature information comprises evaluation information;
the displaying dimension information representing the consumption attribute dimensions and the feature information of the target objects under the consumption attribute dimensions on a search result page, comprises:
displaying, on the search result page, dimension information of the evaluation dimension, and the evaluation information of the target objects under each evaluation attribute in a plurality of evaluation attributes.

20. The computer device according to claim 11, wherein the consumption attribute dimension comprises a purchasing channel dimension, and the feature information comprises purchasing link information;
the displaying dimension information representing the consumption attribute dimensions and the feature information of the target objects under the consumption attribute dimensions on a search result page, comprises:
displaying, on the search result page, dimension information of the purchasing channel dimension, and the purchasing link information of the target object under each purchasing channel in a plurality of the purchasing channels.
